(19) United States
(12) Patent Application Publication
(10) Pub. No.: US 2026/0103935 A1
(43) Pub. Date: Apr. 16, 2026

(54) PROTECTING METHOD AND APPARATUS FOR PASSENGER ON VEHICLE, PROGRAM AND RECORDING MEDIUM

(71) Applicants: Hyundai Motor Company, Seoul (KR); Kia Corporation, Seoul (KR)

(72) Inventor: Hae Sung NAM, Hwaseong-Si (KR)

(21) Appl. No.: 19/320,293

(22) Filed: Sep. 5, 2025

(30) Foreign Application Priority Data
Oct. 11, 2024 (KR) 10-2024-0138531

(51) Int. Cl. E05F 15/40; B60K 35/28

(52) U.S. Cl. CPC E05F 15/40; B60K 35/28; B60K 2360/178; E05Y 2400/356; E05Y 2400/532; E05Y 2400/81; E05Y 2900/531

(57) ABSTRACT

The present disclosure provides a method of protection for a passenger of a vehicle. The method may include determining, via a first sensor of the vehicle, that a door on a first side of the vehicle is ajar. The first side of the vehicle may be associated with a passenger of the vehicle. The method may further include: based on determining that the door of the vehicle being ajar, determining, via a second sensor of the vehicle, whether an object is approaching from a rear side of the vehicle on the first side of the vehicle; and performing, based on determining that the object is approaching, a passenger exit control.

### CROSS-REFERENCE TO RELATED APPLICATION

The present application claims priority to Korean Patent Application No. 10-2024-0138531, filed in the Korean Intellectual Property Office on Oct. 11, 2024, the entire content of which is incorporated herein by reference in its entirety for all purposes.

### TECHNICAL FIELD

The present disclosure relates to vehicle safety systems, and more specifically to exit safety systems for vehicle occupants.

### BACKGROUND

When a driver of a vehicle, a passenger in a passenger seat, or a passenger on a back seat (hereinafter, collectively referred to as “passenger” or “occupant”) exits from a vehicle, the passenger may open a vehicle door without noticing an object, such as a vehicle and a motorcycle, approaching from a rear or lateral side of the vehicle, and the door of the vehicle or the passenger may collide with the object, thereby causing damage to the door of the vehicle or an injury to the passenger.

Autonomous vehicles may include a vehicle terminal corresponding to an autonomous traveling device that is embedded in various traveling means and perform autonomous traveling through traveling location searching. Such an autonomous traveling (e.g., navigation) device has been utilized in the past in a vessel, aircraft, and the like, and recently the autonomous traveling device has been applied to a vehicle that travels on a road. For example, such an autonomous traveling vehicle may inform a user of various types of information on a traveling route, a road traffic situation, and the like via a monitor or autonomously drives the vehicle or controls a traveling state.

In such an autonomous vehicle, when the vehicle is parked or stopped and a passenger exits from the vehicle, the passenger may attempt to exit after a vehicle door is automatically opened. In this case, the passenger may not pay sufficient attention to oncoming traffic (e.g., a vehicle approaching from behind the vehicle) because the passenger did not manually open the door, and thus may not have noticed an object approaching from the rear or the side of the vehicle, which may increase a possibility of collision between the object and the door or between the object and the passenger.

The matters described in this Background section are only for enhancement of understanding of the background of the disclosure, and should not be taken as acknowledgement that they correspond to prior art already known to those skilled in the art.

### SUMMARY

The present disclosure is to resolve the above-described problem, and in a case where a vehicle is parked or stopped, another vehicle approaches from a rear side while a passenger is getting off, the present disclosure is to prevent the approaching vehicle from colliding with the passenger getting off or a door of the vehicle during parking or stopping.

According to one or more example embodiments of the present disclosure, a method performed by an apparatus of a vehicle may include: determining, via a first sensor of the vehicle, that a door on a first side of the vehicle is ajar. The first side of the vehicle may be associated with a passenger of the vehicle. The method may further include: based on determining that the door of the vehicle being ajar, determining, via a second sensor of the vehicle, whether an object is approaching from a rear side of the vehicle on the first side of the vehicle; and performing, based on determining that the object is approaching, a passenger exit control. The passenger exit control may include controlling a movement of the door.

Performing the passenger exit control may be based on an opening angle of the door.

Performing the passenger exit control may include: based on the opening angle of the door being greater than a first angle, outputting, via a user interface of the vehicle, a warning signal.

Performing the passenger exit control may include: controlling, based on the opening angle of the door being between the first angle and a second angle greater than the first angle, the door to reduce the opening angle to a first amount.

The first amount may be a value between ¼ of the opening angle of the door and 5/12 of the opening angle of the door.

Performing the passenger exit control may include: controlling, based on the opening angle of the door being greater than the second angle, the door to reduce the opening angle to a second amount greater than the first amount.

The second amount may be a value between 5/12 of the opening angle of the door and 7/12 of the opening angle of the door.

Performing the passenger exit control may include: controlling, based on determining that the passenger is present between the door and the object, the door to reduce the opening angle at a lower speed of two predetermined speeds associated with the door.

Performing the passenger exit control may include: controlling, based on determining that the passenger is not present between the door and the object, the door to reduce the opening angle at a higher speed of two predetermined speeds associated with the door.

Performing the passenger exit control may include: based on determining that the passenger is leaning against the door, outputting, via a user interface, a warning signal without controlling the door to reduce an opening angle of the door.

The first sensor may be an angle sensor or a variable resistor.

According to one or more example embodiments of the present disclosure, an apparatus of a vehicle may include a first sensor provided on a door on a first side, associated with a passenger, of the vehicle. The first sensor may be configured to detect an object approaching from a rear of the vehicle on the first side. The apparatus may further include: a second sensor configured to determine an opening angle of the door; and a control circuit configured to control, based on measurements of the first sensor and the second sensor, a movement of the door.

The second sensor may include an angle sensor or a variable resistor.

The control circuit may be configured to control the movement of the door by: reducing, based on detecting the object via the first sensor, the opening angle of the door.

The control circuit may be configured to control the movement of the door by: controlling, based on the opening angle of the door determined by the second sensor, opening or closing of the door.

The control circuit may be further configured to: output, via a user interface of the vehicle and based on the opening angle of the door being greater than a first angle, a warning signal; and control, based on the opening angle of the door being between the first angle and a second angle greater than the first angle, the door to reduce the opening angle to a predetermined amount.

The predetermined amount may be a value between ¼ of the opening angle of the door and 5/12 of the opening angle of the door.

The control circuit may be further configured to control the movement of the door by: controlling, based on determining that the passenger is present between the door and the object, the door to reduce the opening angle at a first speed; or controlling, based on determining that the passenger is not present between the door and the object, the door to reduce the opening angle at a second speed greater than the first speed.

### BRIEF DESCRIPTION OF THE DRAWINGS

FIG. 1 illustrates an example safe exit warning system, where a door of a vehicle is opened and an object approaching from a rear/lateral side of the vehicle is sensed.

FIG. 2 is a flow chart for an example protecting method for a passenger on a vehicle.

FIG. 3 is a block diagram illustrating an example safety apparatus for a passenger on a vehicle.

FIG. 4 is diagram illustrating an example case where a door on a passenger's side is opened and there is no vehicle approaching from a rear/lateral side.

FIGS. 5, 6, and 7 are diagrams illustrating adjustment of angles of a door depending on a passenger's location in an example case where a door is opened and there is a vehicle approaching from a rear/lateral side.

FIG. 8 shows an example computing system.

### DETAILED DESCRIPTION

One or more example embodiments of the present disclosure are described in detail with reference to drawings. It should be noted that in imposing reference numerals to elements of each drawing, like elements have like reference numerals as much as possible even if the elements are indicated on other drawings. In addition, in describing the example embodiment(s) of the present disclosure, in a case where it is determined that detailed description about the known related components or functions impedes understanding of the present disclosure, the detailed description is omitted.

In description of the example embodiment(s) according to the present disclosure, in a case where it is described that an element is formed “on or under” each element, the expression “on or under” includes both of cases where two elements are directly in contact with each other and where one or more different elements are formed by being indirectly disposed between the two elements. In addition, expression “on or under” is used, this may mean not only upper direction but also lower direction based on one element.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., detecting an object approaching a vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., detecting an object approaching a vehicle) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., detecting an object approaching a vehicle) described herein.

Minimum risk maneuver (MRM) operation(s) may also be controlled, for example, based on one or more features (e.g., detecting an object approaching a vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., detecting an object approaching a vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., detecting an object approaching a vehicle) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., detecting an object approaching a vehicle) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). For example, the operation control may include, preventing a vehicle door from opening or restricting the maximum angle of opening of the vehicle door (e.g., preventing the door from opening any further).

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth. The target vehicle may be, for example, any object (e.g., an automobile, a motorcycle, a bicycle, a pedestrian, etc.) that is approaching from behind or from the front (e.g., with respect to the host vehicle). The target vehicle may be traveling in an adjacent lane and moving closer to the host vehicle. The target vehicle may not necessarily be in a collision course with the host vehicle but may collide with a door of the host vehicle if the door is opened or collide with an occupant of the vehicle if the occupant exits the vehicle.

In a case where a door is opened because a passenger including a driver exits during traveling of a vehicle and the like, when an object approaching from a rear/lateral side is sensed, the protecting method and apparatus for a passenger on a vehicle according to the present disclosure can prevent collision between an approaching object and a door or a passenger who is about to exit by issuing a warning or reducing an opening angle of the door.

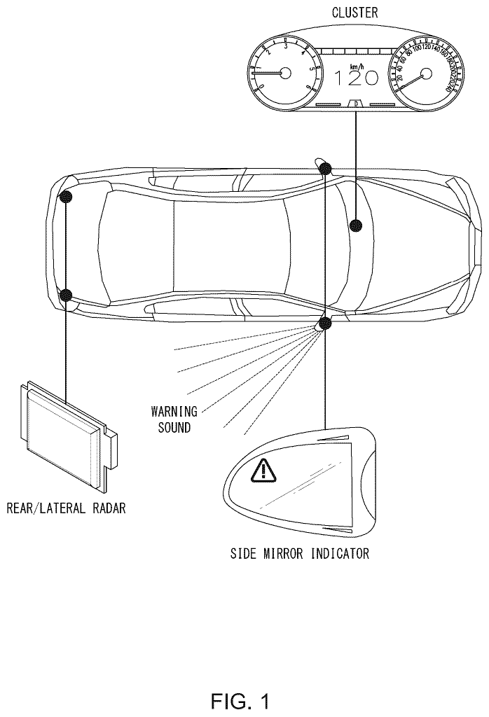

FIG. 1 illustrates an example safe exit warning system, where a door of a vehicle is opened and an object approaching from a rear/lateral side of the vehicle is sensed. An object approaching from a rear or lateral side of a vehicle may be sensed (e.g., via a sensor) when a door of the vehicle is opened. At least in some implementations, a safe exit warning system may generate a warning sound, display a warning message (e.g., by flickering the message on an instrument cluster and the like), or display warning by flickering an indicator light of the door or a side-view mirror provided on the door.

However, while such a system may have an effect of calling attention to the passenger of the vehicle by providing warning, it may not be effective at preventing an accident if the passenger fails to notice or heed the warning.

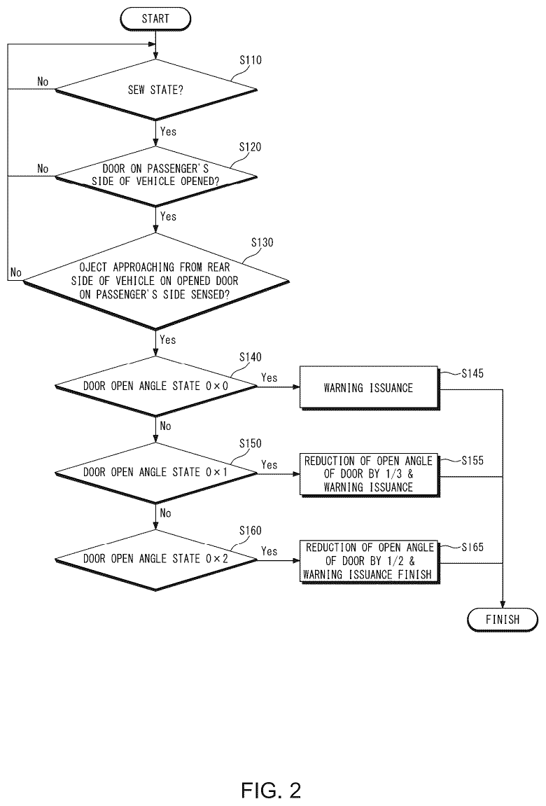

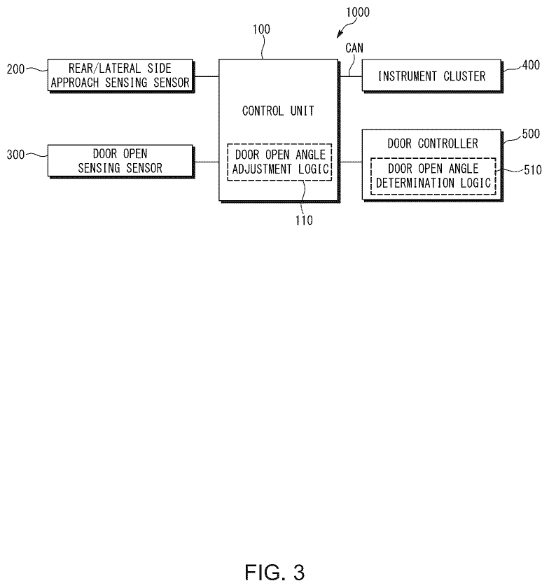

FIG. 2 is a flow chart for an example protecting method for a passenger on a vehicle, and FIG. 3 is a block diagram illustrating an example safety apparatus for a passenger on a vehicle.

Protection method and apparatus for a passenger on a vehicle according to one or more example embodiments of the present disclosure is described with reference to FIGS. 2 and 3.

Protecting method and apparatus for a passenger on a vehicle (1000) may include rear/lateral side approach sensors (also referred to as rear and/or lateral side approach sensing sensors) (200) provided in doors on a passenger's side of a vehicle, a door open sensor (also referred to as a door open sensing sensor) (300) checking (e.g., determining, detecting, etc.) an opened (e.g., ajar) state of doors on a passenger's side of the vehicle, a control unit (also referred to as a control circuit or a controller) (100) provided in the vehicle and controlling operation of a door controller (500) depending on sensing results of the rear/lateral approach sensor and the door open sensor, and the door controller (500) controlling opening and closing of the doors on a passenger's side according to control of the control unit.

The control unit (100) can perform wired and wireless communications with the rear/lateral side approach sensor (200), the door open sensor (300), a cluster (400), and the door controller (500), for example, can perform controller area network (CAN) communication.

The above-described protecting apparatus for a passenger on a vehicle (1000) is provided in a vehicle such as a car, and in a case where a passenger exits (e.g., alights) when a vehicle is parked or stopped, the protecting apparatus for a passenger on a vehicle (1000) can sense an object such as another vehicle approaching from a rear or rear/lateral side and avoid collision. The apparatus is described in detail below.

First, it is checked whether a vehicle is in a safe exit warning (SEW) state or not (S110). The vehicle may be a vehicle that travels in an autonomous traveling method, in addition to a general vehicle, and regarding the SEW state, the mode may be manually turned on or automatically turned on during traveling in the vehicle. If the vehicle is in the SEW state, the SEW system of the vehicle as disclosed herein may be activated and in operation to prevent collision of a vehicle door and/or a vehicle occupant exiting the vehicle with oncoming traffic (e.g., an approaching vehicle in the adjacent traffic lane).

Moreover, the case where an SEW state is turned on in a vehicle may be a state in which the vehicle is not stalled and temporarily parked or stopped.

In a case where the SEW state of the vehicle is turned on (Yes), it may be sensed whether a door on a passenger's side is opened (e.g., ajar) or not (S120). The door on a passenger's side (also referred to as a door associated with a vehicle occupant) means a door provided at a driver's seat, a passenger's seat, or a back seat. The door on the passenger's side may not include a trunk door.

Sensing whether a door on a passenger's side is opened (e.g., ajar) or not may be performed by the above-described door open sensor (300), and the door open sensor (300) may, for example, further provide an angle sensor in a door, or add variable resistor to a door latch rail, and can perform determination by inverse operating an opened amount (e.g., amount of an opening) of the door.

In a case where the door on a passenger's side is not opened (No), it may be continuously sensed (e.g., monitored) whether the door on a passenger's side is opened or not, and in a case where the door on a passenger's side is opened (Yes), an object approaching from a rear side of the opened door on a passenger's side can be sensed (S130). Throughout the present disclosure, example embodiment(s) are described in terms of detecting and preventing collision with an object (e.g., a target vehicle) that is approaching from behind (e.g., with respect to the host vehicle). However, the apparatus, system, and method of the present disclosure may apply to any object (e.g., a target vehicle) that is passing (e.g., projected to pass) alongside the host vehicle (e.g., and come within a threshold distance from the host vehicle) in any direction. For example, the target vehicle may be approaching from the front of the vehicle as well. For example, if a host vehicle is parked in a narrow alleyway or stopped in a two-lane road, the protecting method of the present disclosure may, based on determining that an object is approaching from the front (e.g., traveling in the opposite direction of the travel direction of the target vehicle) and based on determining that a door of the host vehicle being opened (e.g., ajar), a passenger exit control (e.g., closing the door or restricting the opening angle of the door) may be performed. The control unit 100 may determine whether the target vehicle is passing (or is projected to pass) alongside the host vehicle (e.g., from behind the host vehicle or from the front of the host vehicle). In particular, the control unit 100 may determine whether the target vehicle is passing (or is projected to pass) alongside the host vehicle within a threshold distance (e.g., safety distance) from the host vehicle.

The object (e.g., target vehicle) may be another vehicle or motorcycle, or a person or a bicycle approaching the opened door. In addition, the above-described sensing of an object may be performed by the rear/lateral approach sensor (200).

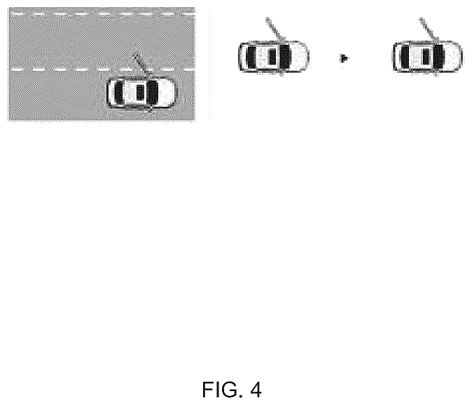

FIG. 4 is diagram illustrating an example case where the door on a passenger's side is opened and there is no vehicle approaching from a rear/lateral side. In a case where an object such as an approaching vehicle is not sensed by the rear/lateral side approach sensor (200) while the door of a vehicle is opened and a passenger exits, any additional door opening and closing operation may not be performed.

In addition, when the above-described approaching object is sensed, safe exit operation of a passenger may be proceeded. In the safe exit operation, a waring sound is issued to call attention to a passenger who exits or an approaching object, a warning is displayed by flickering on a cluster of a vehicle and the like, or a warning is displayed by flickering an indicator of the door or a side-view mirror provided on the door.

The above-described warning can be proceeded via the cluster (400 by performing CAN communication by the control unit (100), or can be proceeded by a horn or a door indicator.

In addition, the safe exit operation of a passenger may be proceeded by reducing an open angle (also referred to as an opening angle) of a door to avoid collision between the opened door and an object in addition to the above-described method. The open angle or opening angle of a door (e.g., vehicle door) may refer to the angle (e.g., rotational angle) at which the door is positioned (e.g., along the door's axis or rotation or hinge) relative to the door's fully closed position. For example, the opening angle of the door may be 0° when the door is fully closed. The opening angle of a fully open door of a vehicle may be, for example, between 70° and 90°. More specifically, the safe exit operation may be proceeded differently depending on the open angle of the door on a passenger's side, and depending on the location of the passenger who exits between the door and the approaching object, and is described in detail below.

The above-described open angle of the door can be divided into a case where the open angle of the door on a passenger's side is the smallest, a case where the open angle of the door on a passenger's side is the intermediate, and a case where the open angle of the door on a passenger's side is the largest. At this time, regarding the open angle of the door in the three cases, for example, the case where the open angle of the door is the smallest is a case where the door is subtly opened, the case where the open angle of the door on a passenger's side is the intermediate is a case where the open angle of the door on a passenger's side is 0° to 30°, and the case where the open angle of the door on a passenger's side is the largest is a case where the open angle of the door is equal to or more than 30°.

Moreover, when the open angle of a passenger's side is the smallest (e.g., the angle of the open door is within a first range of angles or below a first angle) (S140, Yes), the door is in a state of being subtly opened (e.g., slightly ajar), and thus only a warning can be issued without reducing the open angle of the door (S145). The “warning” may be a method of setting off a warning sound to call attention to a passenger who exits or an approaching object, displaying a warning by flickering on a cluster of a vehicle and the like, or flickering an indicator of the door or a side-view mirror provided in the door, as described above, and the same applies hereinafter. The warning may be issued via a user interface of the vehicle. The user interface may include any input or output device of the vehicle that a passenger (e.g., occupant) of the vehicle may interact with, such as a console, a dashboard, a lamp, a light, an indicator, a speaker, a display, a screen, a touch screen, a button, a knob, a slider, etc.

In addition, when the open angle of the door on a passenger's side is the intermediate (e.g., the angle of the open door is within a second range of angles greater than the first range of angles or between the first angle and a second angle greater than the first angle) (S150, Yes), the safe exit operation of a passenger may be at least one of reducing the open angle of the door on a passenger's side or issuing a warning (S155). At this time, the open angle of the door on a passenger's side can be reduced to ⅓ (e.g., between ¼ and 5/12) of the previous open angle, for example, when the open angle of the door on a passenger's side is 15°, the open angle of the door on a passenger's side can be reduced to 5°.

In addition, when the open angle of the door on a passenger's side is the largest (e.g., the angle of the open door is within a third range of angles greater than the second range of angles or greater than the second angle) (S160, Yes), the safe exit operation for a passenger may be at least one of reducing the open angle of the door on a passenger's side or issuing a warning (S165). At this time, the open angle of the door on a passenger's side can be reduced to ½ (e.g., between 5/12 and 7/12) of the previous open angle, for example, when the open angle of the door on a passenger's side is 50°, the open angle of the door on a passenger's side can be reduced to 25°.

In Steps S155 and S165, the open angle of a door is reduced, that is, the door is folded (e.g., swung in, closed, etc.) to avoid collision between an object approaching from a rear/lateral side and the opened door, and since the open angle of the door is larger in S165 than in S155, the door can be folded more in S165 than in S155.

In addition, when the door on a passenger's side is folded in Steps S155 and S165, a passenger who exits should not collide with the door, and thus reduction in the open angle of the door, that is, folding of the door is needed to be adjusted as follows.

For example, in a case where a passenger who exits is present between the door on a passenger's side and the sensed object, reduction in the open angle of the door is proceeded slowly (e.g., at a lower speed of two predetermined speeds) to protect the passenger who exits, and in a case where a passenger who exits is not present between the door on a passenger's side and the sensed object, reduction in the open angle of the door can be proceeded fast (e.g., at a higher speed of two predetermined speeds).

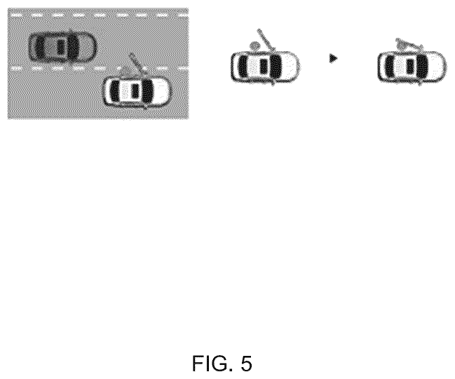

FIG. 5 is a diagram illustrating an example case where a door on a passenger's side (e.g., the side of the vehicle that an occupant is attempting to exit on) is opened (e.g., ajar), there is a vehicle (e.g., a target vehicle) approaching from a rea/lateral side, and a passenger is located between the vehicle on the rear side and the door. The control unit 100 may determine that the target vehicle is passing (or is projected to pass) alongside the host vehicle (e.g., from behind the host vehicle or from the front of the host vehicle). In particular, the control unit 100 may determine that the target vehicle is passing (or is projected to pass) alongside the host vehicle and come within a threshold distance (e.g., safety distance) from the host vehicle. At this time, the open angle of the door may become small, that is, the door may be folded (e.g., swung in, shut, closed, etc.), to avoid collision between the passenger who exits or the door and the vehicle approaching from the rear side, the door may not be completely closed or a speed at which the door is closed may be relatively slow in order to avoid collision between the passenger and the door.

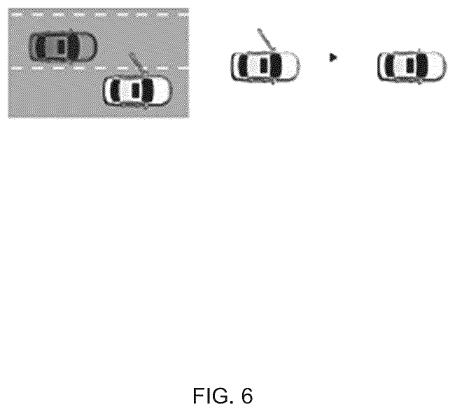

FIG. 6 is a diagram illustrating an example case where a door on a passenger's side is opened, there is a vehicle approaching from a rear/lateral side, and a passenger is not present between the vehicle on the rear side and the door. At this time, the open angle of the door becomes small to avoid collision between the door and the vehicle approaching from a rear side, and the door may be completely closed or a speed at which the door is closed may be relatively fast.

In addition, in a case where the passenger leans against the door on a passenger's side, when the door is automatically folded, the passenger may fall down, and thus only the above-described warning may be issued without the reduction in the open angle of the door.

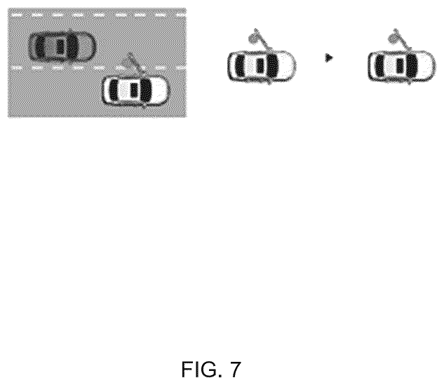

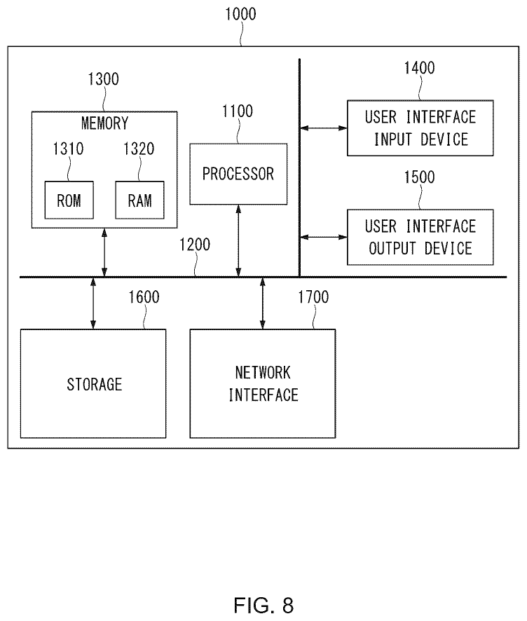

FIG. 7 is a diagram illustrating an example case where a door on a passenger's side is opened, there is a vehicle approaching from a rear/lateral side, and a passenger leans against the door. At this time, when the door is automatically moved, the passenger may get hurt, and thus any additional door opening and closing operation may not be performed.

In the example embodiment(s) described herein, a case where a passenger exits while a vehicle is parked or stopped is exemplified, but the present disclosure may apply to a case where a passenger enter a vehicle that is parked or stopped.

The above-described folding angle or folding speed of a door may be set by sending a control signal from the control unit (100) to the door controller (500) via CAN communication and directly folding a door on a passenger's side by the door controller (500).

In addition, for example, as illustrated in FIG. 2, a door open angle adjustment logic (110) may be proceeded in the control unit (100), and a door open angle determination logic (510) may be proceeded in the door controller (500).

Computer-readable instructions (e.g., programs) associated with the protecting method as described herein for a passenger on a vehicle, may be executed by a processor and recorded on a computer-readable recording medium.

FIG. 5 shows an example computing system (e.g., a computing device of a vehicle or any other apparatus). One or more controllers, processors, etc. described herein (e.g., control unit 100, door open angle adjustment logic 110, rear/lateral side approach sensor 200, door open sensor 300, instrument cluster 400, door controller 500, door open angle determination logic 510, etc.) may be implemented by the computing system or may be implemented in the computing system.

A computing system (also referred as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure provides a protecting method for a passenger on a vehicle, including checking that a door on a passenger's side of the vehicle is opened, when the door on a passenger's side is opened, sensing an object approaching from a rear side of the opened door on a passenger's side, and when the approaching object is sensed, performing a passenger exit control.

The present disclosure also provides a vehicle including a rear/lateral side approach sensing sensor provided on a door on a passenger's side of the vehicle, a door open sensing sensor for determining an opened state of the door on a passenger's side of the vehicle, and a controller configured to control opening or closing the door, according to sensing results of the rear/lateral side approach sensing sensor and the door open sensing sensor.

The passenger exit control may be proceeded differently depending on an open angle of a door on a passenger's side.

When the open angle of the door on a passenger's side reaches a first angle (e.g. the smallest angle), the passenger exit control may be a warning issuance.

When the open angle of the door on a passenger's side is between the first angle and a second angle, i.e. in the intermediate range, the passenger exit control may be at least any one of a reduction in the open angle of the door on a passenger's side and the warning issuance.

When the reduction in the open angle of the door on a passenger's side may reduce the open angle of the door on a passenger's side by ⅓.

When the open angle of the door on a passenger's side reaches the second angle (e.g. the largest angle), the passenger exit control may be at least any one of the reduction in the open angle of the door on a passenger's side and the warning issuance.

The reduction in the open angle of the door on a passenger's side may reduce the open angle of the door on a passenger's side by ½.

In a case where the passenger is present between the door on a passenger's side and the sensed object, reduction in the open angle of the door may be proceeded slowly (e.g. at a first speed).

In a case where the passenger is not present between the door on a passenger's side and the sensed object, reduction in the open angle of the door may be proceeded fast (e.g. at a second speed).

In a case where the passenger leans against the door on a passenger's side, only the warning issuance may occur without the reduction in the open angle of the door.

Whether the door on a passenger's side of the vehicle is opened or not can be measured by an angle sensor provided on the door on a passenger's side of the vehicle or variable resistance.

A program which is characterized in that the protecting method for a passenger on a vehicle may be executed by a processor and which is recorded on a computer-readable recording medium.

A computer-readable recording medium in which the above-described program may be recorded.

According to the protecting method and apparatus for a passenger on a vehicle, the program, and the recording medium according to the present disclosure, while a vehicle is traveling, in a case where the vehicle is parked or stopped and a driver or a passenger exits or enters the vehicle, it is possible to protect the passenger or an opened door against another approaching vehicle by operating a safe exit warning mode, sensing another vehicle approaching from a rear/lateral side, and in a case where another vehicle is approaching, issuing a warning, or folding the opened door under a certain condition.

According to the above-described protecting method and apparatus for a passenger on a vehicle, the program, and the recording medium according to the present disclosure, while a vehicle is traveling, in particular, an autonomous vehicle is traveling, in a case where the vehicle is parked or stopped and a driver or a passenger exits or enters the vehicle, it is possible to protect the passenger or an opened door against another approaching vehicle by operating a safe exit warning mode, sensing another vehicle approaching from a rear/lateral side, and in a case where another vehicle is approaching, issuing a warning, or folding the opened door under a certain condition.

Hereinabove, even if all elements constituting example embodiment(s) of the present disclosure are described as being combined as one or operating by being combined, the present disclosure is not necessarily limited to the embodiment(s). That is, within the range of the object of the present disclosure, one or more of all the elements may be selectively combined and operated. In addition, it should be understood that the term “include”, “comprise”, or “have” described above means that the element is inherent unless otherwise described, and thus should be construed as further including other elements, not excluding other elements. Unless otherwise defined, all terms used herein, including technical or scientific terms, include the same meaning as that generally understood by those skilled in the art. It will be understood that terms, such as those defined in commonly used dictionaries, should be interpreted as including a meaning which is consistent with their meaning in the context of the relevant art and will not be interpreted in an idealized or overly formal sense unless so defined herein.

The above description is merely an exemplary description about a technical idea of the present disclosure, and can be variously modified and implemented within a range of not departing from the essential properties of the present disclosure by those skilled in the art under which the present disclosure falls. Therefore, the example embodiment(s) disclosed in the present disclosure are not intended to limit the technical idea of the present disclosure but to describe thereof, and the example embodiment(s) do not limit the range of the technical idea of the present disclosure. The protection scope of the present specification should be construed by the scope of claims, and all technical ideas within the equivalent range should be construed to be included in the scope of the present specification.

What is claimed is:

1. A method performed by an apparatus of a vehicle, the method comprising:
determining, via a first sensor of the vehicle, that a door on a first side of the vehicle is ajar, wherein the first side of the vehicle is associated with a passenger of the vehicle;
based on determining that the door of the vehicle being ajar, determining, via a second sensor of the vehicle, whether an object is approaching from a rear side of the vehicle on the first side of the vehicle; and
controlling, based on determining that the object is approaching, a movement of the door to avoid a collision between the object and the door.

2. The method according to claim 1, wherein the controlling a movement of the door is based on an opening angle of the door.

3. The method according to claim 2, wherein the controlling a movement of the door comprises:
based on the opening angle of the door being greater than a first angle, outputting, via a user interface of the vehicle, a warning signal.

4. The method according to claim 3, wherein the controlling a movement of the door comprises:
controlling, based on the opening angle of the door being between the first angle and a second angle greater than the first angle, the door to reduce the opening angle to a first amount.

5. The method according to claim 4, wherein the first amount is a value between ¼ of the opening angle of the door and 5/12 of the opening angle of the door.

6. The method according to claim 4, wherein the controlling a movement of the door comprises:
controlling, based on the opening angle of the door being greater than the second angle, the door to reduce the opening angle to a second amount greater than the first amount.

7. The method according to claim 6, wherein the second amount is a value between 5/12 of the opening angle of the door and 7/12 of the opening angle of the door.

8. The method according to claim 4, wherein the controlling a movement of the door comprises:
controlling, based on determining that the passenger is present between the door and the object, the door to reduce the opening angle at a lower speed of two predetermined speeds associated with the door.

9. The method according to claim 4, wherein the controlling a movement of the door comprises:
controlling, based on determining that the passenger is not present between the door and the object, the door to reduce the opening angle at a higher speed of two predetermined speeds associated with the door.

10. The method according to claim 1, wherein the controlling a movement of the door comprises:
based on determining that the passenger is leaning against the door, outputting, via a user interface, a warning signal without controlling the door to reduce an opening angle of the door.

11. The method according to claim 1, wherein the first sensor is an angle sensor or a variable resistor.

12. An apparatus of a vehicle, the apparatus comprising:
a first sensor provided on a door on a first side, associated with a passenger, of the vehicle, wherein the first sensor is configured to detect an object approaching from a rear of the vehicle on the first side;
a second sensor configured to determine an opening angle of the door; and
a control circuit configured to control, based on measurements of the first sensor and the second sensor, a movement of the door.

13. The apparatus according to claim 12, wherein the second sensor comprises an angle sensor or a variable resistor.

14. The apparatus according to claim 12, wherein the control circuit is configured to control the movement of the door by:
reducing, based on detecting the object via the first sensor, the opening angle of the door.

15. The apparatus according to claim 12, wherein the control circuit is configured to control the movement of the door by:
controlling, based on the opening angle of the door determined by the second sensor, opening or closing of the door.

16. The apparatus according to claim 12, wherein the control circuit is further configured to:
output, via a user interface of the vehicle and based on the opening angle of the door being greater than a first angle, a warning signal; and
control, based on the opening angle of the door being between the first angle and a second angle greater than the first angle, the door to reduce the opening angle to a predetermined amount.

17. The apparatus according to claim 16, wherein the predetermined amount is a value between ¼ of the opening angle of the door and 5/12 of the opening angle of the door.

18. The apparatus according to claim 12, wherein the control circuit is further configured to control the movement of the door by:
controlling, based on determining that the passenger is present between the door and the object, the door to reduce the opening angle at a first speed; or
controlling, based on determining that the passenger is not present between the door and the object, the door to reduce the opening angle at a second speed greater than the first speed.

19. A method performed by an apparatus of a vehicle, the method comprising:
determining, via a first sensor of the vehicle, that a door on a first side of the vehicle is ajar;
based on determining that the door of the vehicle being ajar, determining, via a second sensor of the vehicle, whether an object is projected to pass alongside the vehicle within a threshold distance from the vehicle; and
controlling, based on determining that the object is projected to pass alongside the vehicle within the threshold distance from the vehicle, a movement of the door to avoid a collision between the object and the door.

20. The method according to claim 19, further comprising:
detecting, based on a third sensor of the vehicle, a movement of a passenger associated with the door,
wherein the controlling of the movement of the door comprises controlling, based on the movement of the passenger, at least one of:
a speed of the movement of the door, or
an amount of an opening angle of the door.
